(19) United States
(12) Patent Application Publication
(10) Pub. No.: US 2003/0000348 A1
(43) Pub. Date: Jan. 2, 2003

(54) Ratchet tool mechanism

(76) Inventor: David A. Giardino, Rock Hill, SC (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 09/893,923

(22) Filed: Jun. 28, 2001

(51) Int. Cl. B25B 17/00; B25B 13/46

(52) U.S. Cl. 81/57.39

(57) ABSTRACT

The present invention relates generally to ratchet tools and in particular to a device to reduce spreading of the head of the ratchet tool. According to the present invention, a novel thrust washer is provided which prevents spreading apart of the head. The thrust washer is characterized by a decreased overall-diameter to edge-height ratio. The present invention also presents an alternative embodiment in which the height of the thrust washer is decreased while the height of the shank spindle is increased to prevent spreading of the head.

### BACKGROUND OF THE INVENTION

1. Technical Field

The present invention relates generally to ratchet tools. According to the present invention, a ratchet tool is provided which prevents spreading apart of the head of the ratchet tool.

2. Related Art

Pneumatic, and other, ratchet tools operate by reciprocating movement of a yoke that engages a pawl. The pawl is connected to a shank spindle and is selectively positionable such that the yoke, when reciprocating, engages the pawl to forcibly turn the pawl and shank spindle in a selected direction. The shank spindle includes a shank spindle output shaft, to which is commonly attached a socket, which is then applied to a workpiece being operated upon. Typically this workpiece may be a nut or bolt.

In the related art, proper operation of the ratchet tool is reliant upon retainment of the shank spindle in the head via at least one thrust washer, possibly in combination with one or more retaining rings. See, for example, U.S. Pat. No. 5,896,789 to Giardino, incorporated herein by reference.

A common occurrence during operation is for the socket to become misaligned or cocked on the nut. When this happens, the ratchet tool user typically forcefully moves the ratchet tool back and force in an attempt to loosen the socket from the nut. The back and force movement imparts a lateral force on the shank spindle output shaft, and a moment arm is created which causes movement of the thrust washers within the head. This movement of the thrust washers in turn causes the head to spread apart, resulting in loosening of the component parts and diminished performance of the ratchet tool.

It is therefore a feature of the present invention to provide a thrust washer which prevents spreading of the head of the ratchet tool.

### SUMMARY OF THE INVENTION

The present invention overcomes the above deficiencies by providing a thrust washer having a smaller overall-diameter to edge-height ratio than the overall-diameter to edge-height ratio of the related art thrust washer. Overall-diameter refers to the diameter of the thrust washer measured at the outer edge of the thrust washer. Similarly, edge-height refers to the height or thickness of the thrust washer at its outer edge. The smaller overall-diameter to edge-height ratio is obtained by increasing the edge-height of the thrust washer, which will eliminate spreading of the head. In an alternative embodiment of the invention, a thrust washer is used in combination with a shank spindle having an increased thickness at those regions that contact the thrust washer.

The present invention is also drawn to a ratchet tool incorporating the thrust washers described above, and a method of operation of a ratchet tool using the above teachings.

In a first general aspect, the present invention provides a ratchet tool comprising: a ratchet head, said head including at least two members; a shank spindle operationally attached to said ratchet head; a shank spindle output shaft operationally attached to said shank spindle; and at least one thrust washer operationally attached to said shank spindle, wherein said thrust washer prevents spreading of the head when a force is applied to the shank spindle output shaft.

In a second general aspect, the present invention provides a thrust washer for use in a ratchet tool, wherein the ratchet tool includes a shank spindle, a ratchet head including at least two members, a shank spindle output shaft, and at least one thrust washer, said thrust washer comprising: a first surface and a second surface, each having an overall-diameter; a peripheral surface having an edge-height; an opening in said thrust washer, said opening having an edge, said edge having an edge-height, and said opening extending through the thrust washer from said first surface to said second surface, and said opening being concentric to said peripheral surface; and wherein said first surface and said second surface are substantially parallel to each other.

In a third general aspect, the present invention provides a method of reducing spreading of a ratchet head, said method comprising: providing a ratchet head; providing a shank spindle operationally connected to said ratchet head; providing at least one thrust washer operationally connected to said shank spindle; locating said thrust washer such that said thrust washer is operationally attached to the ratchet head and said shank spindle; and providing the at least one thrust washer characterized by a diameter to height ratio such that spreading of the ratchet head is prevented.

In a fourth general aspect, the present invention provides a method of reducing spreading of a ratchet head comprising: providing a shank spindle operationally connected to said ratchet head, wherein said ratchet head includes two members separated by a member gap having a member gap dimension; providing at least one thrust washer operationally attached to said shank spindle, wherein said thrust washer has an edge-height dimension; providing a shank spindle operationally attached to said ratchet head, wherein said shank spindle has a height dimension; orienting said thrust washer such that said thrust washer is sandwiched in the member gap, between the ratchet head and the shank spindle; and characterizing said thrust washer edge-height dimension and said shank spindle height dimension such that the combined structure of the thrust washer and the shank spindle substantially fills the member gap dimension to prevent spreading of the ratchet head.

In a fifth general aspect, the present invention provides a tool comprising: comprising: a shank spindle operationally connected to a ratchet head; a shank spindle output shaft operationally connected to said shank spindle, wherein said shank spindle output shaft is subjected to a lateral force, and wherein said lateral force tends to cause a corresponding movement in the head; at least one thrust washer operationally attached to said shank spindle; and wherein said at least one thrust washer prevents the corresponding movement in the ratchet head when said lateral force is applied.

The foregoing and other features and advantages of the invention will be apparent from the following more particular description of embodiments of the invention.

### BRIEF DESCRIPTION OF THE DRAWINGS

The embodiments of this invention will be described in detail, with reference to the following figures, wherein like designations denote like elements, and wherein:

FIG. 1 shows a cross-sectional side view of a portion of a ratchet tool of the related art.

FIG. 2 shows a cross-sectional side view of a portion of a ratchet tool in accordance with a first embodiment of the present invention.

FIG. 3 shows a cross-sectional side view of a portion of a ratchet tool in accordance with a second embodiment of the present invention.

FIG. 4A shows a plan view of a related art embodiment of a stepped thrust washer having a first overall-diameter to edge-height ratio.

FIG. 4B shows a cross-sectional view of the related art stepped thrust washer of FIG. 4A.

FIG. 5A shows a plan view of a thick non-stepped thrust washer having a decreased overall-diameter to edge-height ratio in accordance with an embodiment of the present invention.

FIG. 5B shows a cross-sectional view of the thick non-stepped thrust washer of FIG. 5A.

FIG. 6A shows a plan view of a thin non-stepped thrust washer having a decreased overall-diameter to edge-height ratio in accordance with an embodiment of the present invention.

FIG. 6B shows a cross-sectional view of the thin non-stepped thrust washer of FIG. 6A.

### DESCRIPTION OF THE EMBODIMENTS

While the present invention will be described for use in ratchet tool, such as, inter alia, a fluid driven ratchet tool, one of ordinary skill in the art should recognize that the present invention is not limited to such devices. For instance, the teachings of the present invention can be used in any ratchet tool with or without a fluid driven motor, e.g., an electrically operated ratchet tool.

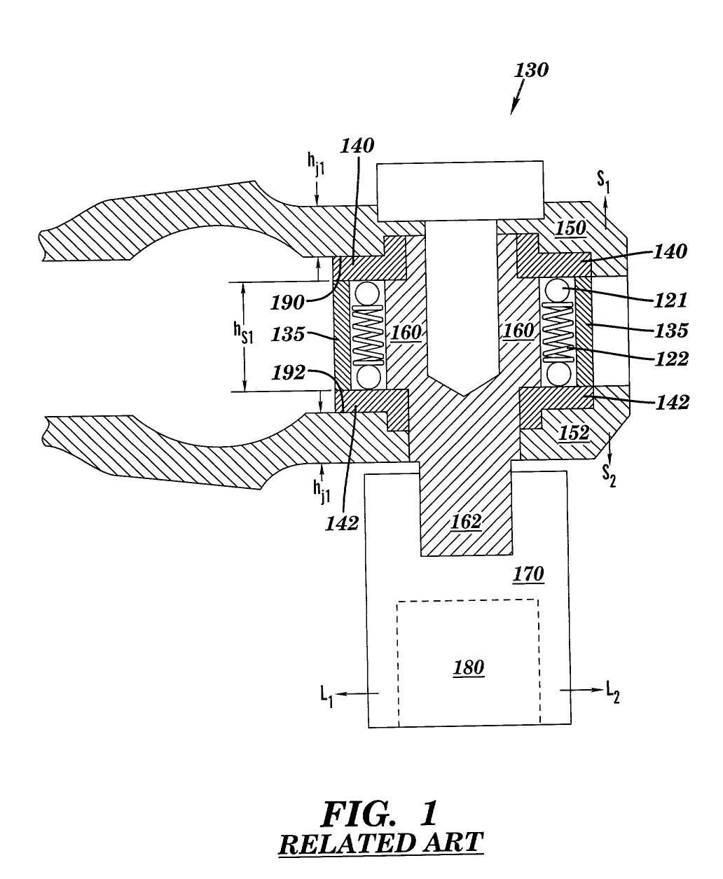

FIG. 1 discloses a cross-sectional side view of a portion of a ratchet head 130 of the related art. Ratchet head 130 comprises a first member 150 and a second member 152. Each member 150, 152 is characterized by a first member height hⱼ₁. The first member 150 includes a first interior surface 190, while the second member 152 similarly includes a second interior surface 192. The first and second interior surfaces 190, 192 of the members 150, 152 are operationally engaged by one or more stepped thrust washers 140, 142. A shank spindle 160 is operationally fixed in the ratchet head 130 between the members 150, 152. The shank spindle 160 is characterized by an inner height hₛ₁. The shank spindle 160 is also operationally engaged by the one or more stepped thrust washers 140, 142. A biasing device such as, inter alia, spring-biased ball bearings 121 and bias springs 122, are provided which force the thrust washers 140, 142 to bear upon the first and second interior surfaces 190, 192. The spring-biased ball bearings 121 may be used in either single (not shown) or double form. A shank spindle output shaft 162 of the shank spindle 160 is operationally attached to a socket 170, or similar device, having a socket opening 180 for attachment to a workpiece (not shown) such as, inter alia, a nut or bolt.

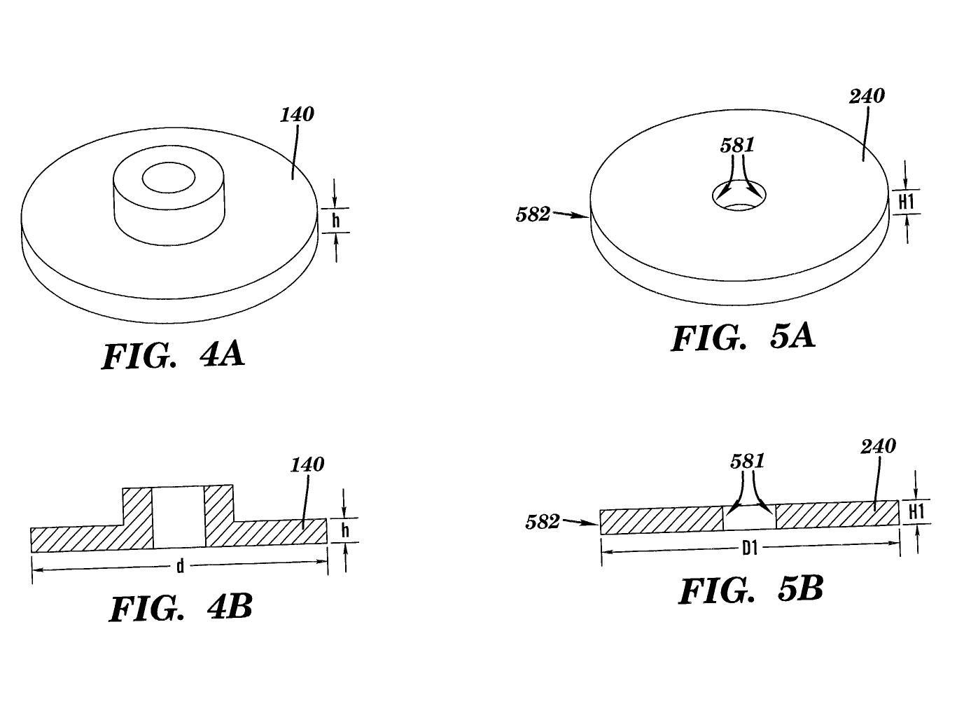

The stepped thrust washers 140, 142 of the related art embodiment shown in FIG. 1 are characterized by an overall-diameter dimension d, and a edge-height dimension h measured at the outer peripheral edge of the stepped thrust washer (see FIGS. 4A and 4B). Combining these two dimensions yields an overall-diameter to edge-height ratio of d/h.

One problem with the related art embodiments, which the present invention overcomes, becomes evident when a lateral force L₁ or L₂ is applied to the socket 170. The lateral force, L₁ or L₂, creates a moment arm in the yoke 135 of ratchet head 130 which produces movement of the first and second stepped thrust washers 140, 142. Movement of the stepped thrust washers 140, 142 in turn imparts a force S₁ on the first member 150 and a force S₂ on the second member 152. Forces S₁ and S₂ produce a tendency for spreading apart of the first and second members 150, 152, resulting in increased wear of ratchet tool component parts and diminished ratchet tool performance.

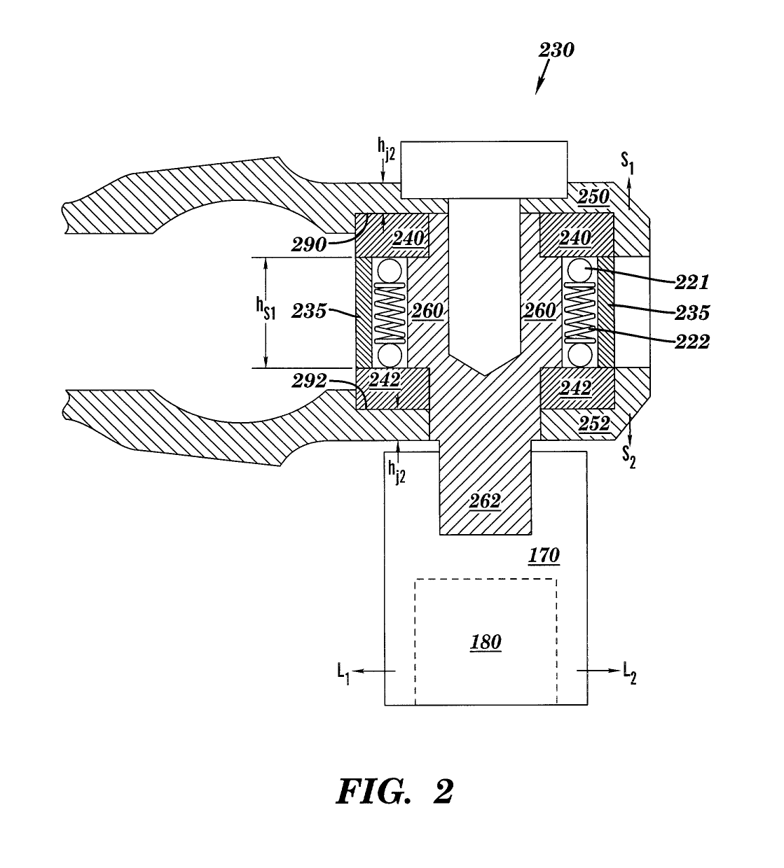

A ratchet head 230 in accordance with a first embodiment of the present invention is shown in FIG. 2. The ratchet head 230 comprises a first member 250 and a second member 252. Each member 250, 252 is characterized by a second member height hⱼ₂, which is smaller than the first member height hⱼ₁ of the related art embodiment. The first member 250 includes a first interior surface 290, while the second member 252 similarly includes a second interior surface 292. The first and second interior surfaces 290, 292 of the ratchet head 230 are operationally engaged by one or more thick non-stepped thrust washers 240, 242. A shank spindle 260 is operationally fixed in the ratchet head 230. The shank spindle 260 is characterized by the same inner height hₛ₁ as the related art embodiment. The shank spindle 260 is also operationally engaged by the one or more thick non-stepped thrust washers 240, 242. A biasing device such as, inter alia, spring-biased ball bearings 221 and bias springs 222, are provided which force the thrust washers 240, 242 to bear upon the first and second interior surfaces 290, 292. The spring-biased ball bearings 221 may be used in either single (not shown) or double form. A shank spindle output shaft 262 of the shank spindle 260 is operationally attached to a socket 170, or similar device, having a socket opening 180 for attachment to a workpiece.

The improved thick non-stepped thrust washers 240, 242 do not have a stepped contour profile. Rather, the thick non-stepped thrust washers 240, 242 are characterized by substantially co-parallel upper and lower surfaces. The thick non-stepped thrust washers 240, 242 are further characterized a decreased overall-diameter to edge-height ratio, that is, the thick non-stepped thrust washers 240, 242 have the same thickness or height H1 at their inner bore 581 (see FIGS. 5A and 5B) as at their outer edge 582. The thick non-stepped thrust washers 240, 242 of this embodiment of the present invention are characterized by an overall diameter dimension D1, equal to the related art stepped thrust washer's overall diameter d, and an edge-height dimension H1 measured at the outer peripheral edge of the thick non-stepped thrust washer 240 which is greater than the related art stepped thrust washer's edge-height dimension h. Combining these two dimensions yields an overall-diameter to edge-height ratio D1/H1, which ratio is smaller than the related art stepped thrust washer's overall-diameter to edge-height ratio d/h.

According to this first embodiment of the present invention, when a lateral force L₁ or L₂ is applied to the socket 170, the lateral force, L₁ or L₂, will not create a moment arm in the yoke 235 of the ratchet head 230. Therefore, movement of the first and second thick non-stepped thrust washers 240, 242 will be prevented. Consequently, force S₁ on the first head 250 and force S₂ on the second head 252 will also be prevented, so that any spreading of the first and second members 250, 252 is similarly prevented.

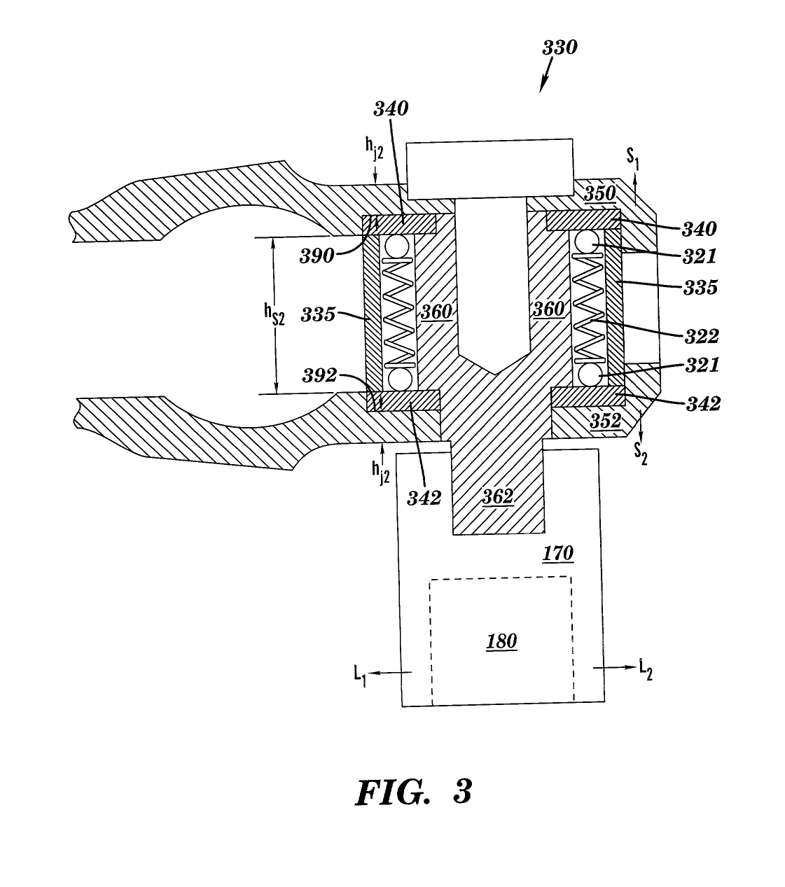

FIG. 3 depicts a cross-sectional view of a second embodiment of a ratchet head 330. Ratchet head 330 comprises a first member 350 and a second member 352. Each member 350, 352 is characterized by the second member height hⱼ₂, which is smaller than the first member height hⱼ₁ of the related art embodiment. The first member 350 includes a first interior surface 390, while the second member 352 similarly includes a second interior surface 392. The first and second interior surfaces 390, 392 of the ratchet head 330 are operationally engaged by one or more thin non-stepped thrust washers 340, 342. A biasing device such as, inter alia, spring-biased ball bearings 321 and bias springs 322, are provided which force the thrust washers 340, 342 to bear upon the first and second interior surfaces 390, 392. The spring-biased ball bearings 321 may be used in either single (not shown) or double form. A shank spindle 360 is operationally fixed in the ratchet head 330. The shank spindle 360 is characterized by an inner height hₛ₂ which is greater than the inner height hₛ₁ of the first embodiment of the present invention. The shank spindle 360 is also operationally engaged by the one or more thin non-stepped thrust washers 340, 342. A shank spindle output shaft 362 of the shank spindle 360 is operationally attached to a socket 170, or similar device, having a socket opening 180 for attachment to a workpiece.

The thin non-stepped thrust washers have a decreased diameter to height ratio as compared to the stepped thrust washers 140, 142 of the related art shown in FIG. 1. The improved thin non-stepped thrust washer 340, 342 do not have a stepped contour profile.

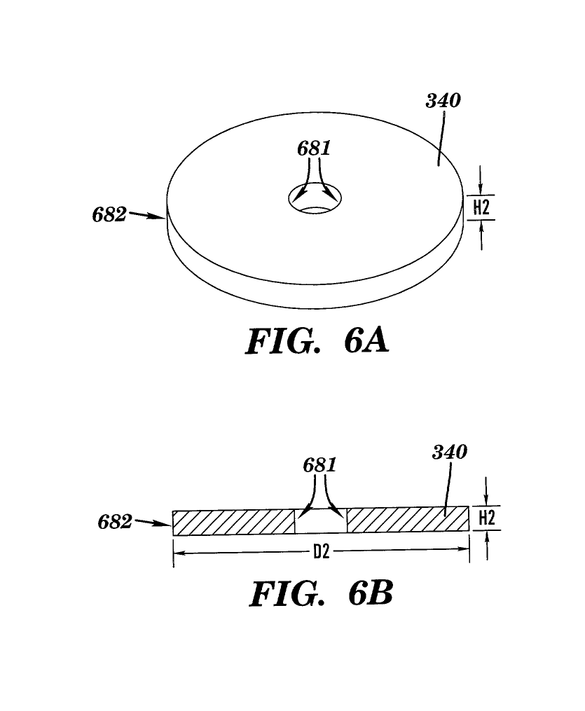

The thin non-stepped thrust washers 340, 342 are characterized by a decreased overall-diameter to edge-height ratio, that is, the thin non-stepped thrust washers 340 have the same thickness or height H2 at their inner bore 681 as at their outer edge 682 (see FIGS. 6A and 6B). The thin non-stepped thrust washers 340 of this embodiment of the present invention are characterized by an overall-diameter dimension D2, equal to the related art stepped thrust washer's overall-diameter d, and an edge-height dimension H2 measured at the outer peripheral edge of the thrust washer 340 which is greater than the related art stepped thrust washer's edge-height dimension h. Combining these two dimensions yields an overall-diameter to edge-height ratio D2/H2, which is smaller than the related art stepped thrust washer's overall-diameter to edge-height ratio d/h.

A corresponding increase in the inner height hₛ₂ (FIG. 3) of the shank spindle may be employed to accommodate the reduced height dimension of the thin non-stepped thrust washers 340, 342. Alternatively, a plurality of thin non-stepped washers 340, 342 may be stacked to achieve a desired height and employed in place of the thick non-stepped washers 240, 242 (FIG. 2).

According to this second embodiment of the present invention, when a lateral force L₁ or L₂ is applied to the socket 170, the lateral force, L₁ or L₂, will not create a moment arm in the yoke 335 of the ratchet head 330. Therefore, movement of the first and second thin non-stepped thrust washers 340, 342 will be prevented. Consequently, force S₁ on the first head 350 and force S₂ on the second head 352 will be prevented, so that any spreading of the first and second head 350, 352 is similarly prevented.

Referring now to FIGS. 4A and 4B, a plan view and cross-sectional view, respectively, of related art embodiment of a stepped thrust washer 140 is shown. The stepped thrust washer 140 is characterized by an overall-diameter d and an edge-height h. The edge-height h is defined as the height at the periphery or overall-diameter of the stepped thrust washer 140. The overall-diameter to edge-height ratio d/h can thus be established for this stepped thrust washer 140.

FIGS. 5A and 5B show a plan view and a cross-sectional view, respectively, of the novel thick non-stepped thrust washer 240 having a decreased overall-diameter to edge-height ratio in accordance with an embodiment of the present invention. The thick non-stepped thrust washer 240 is characterized by an overall-diameter D1 and an edge-height H1. The edge-height H1 is defined as the height at the periphery or overall-diameter of the thick non-stepped thrust washer 240. The overall-diameter to edge-height ratio D1/H1 can thus be established for this thick non-stepped thrust washer 240. Comparing the overall-diameter to edge-height ratio of the stepped thrust washer (i.e., d/h) to the thick non-stepped washer (i.e., D1/H1), it can be seen that a decrease in this ratio is desirable, as it is indicative of a thick non-stepped thrust washer 240.

Non-stepped thrust washers may be employed in either a “thick” version (240, 242 in FIG. 2) or a “thin” version (340, 342 in FIG. 3) with a correspondingly sized shank spindle 260, 360. FIGS. 6A and 6B show a plan view and a cross-sectional view, respectively, of the novel thin non-stepped thrust washer 340 having a decreased overall-diameter to edge-height ratio in accordance with an embodiment of the present invention. The thin non-stepped thrust washer 340 is characterized by an overall-diameter D2 and an edge-height H2. The edge-height H2 is defined as the height at the periphery or overall-diameter of the non-stepped thrust washer 340. The overall-diameter to edge-height ratio D2/H2 can thus be established for this non-stepped thrust washer 340. Comparing the overall-diameter to edge-height ratio of the stepped thrust washer (i.e., d/h) to the thin non-stepped washer (i.e., D2/H2), it can be seen that a decrease in this ratio is desirable, as it is indicative of a thin non-stepped thrust washer 340.

Non-stepped thrust washers may further be employed in either a continuous or discontinuous ring form. That is, the non-stepped thrust washers may have the continuous form of the letter “O”, or the discontinuous form of the letter “C”. Other embodiments known to those skilled in the art will be readily apparent, such as, inter alia, a split-ring form or a helical form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A ratchet tool comprising:
a ratchet head, said head including at least two members;
a shank spindle operationally attached to said ratchet head;
a shank spindle output shaft operationally attached to said shank spindle; and
at least one thrust washer operationally attached to said shank spindle, wherein said thrust washer prevents spreading of the ratchet head when a force is applied to the shank spindle output shaft.

2. The ratchet tool of claim 1, wherein the thrust washer is a non-stepped thrust washer.

3. The ratchet tool of claim 2, wherein said thrust washer has an upper surface and a lower surface, and wherein said upper surface and said lower surface are substantially co-parallel.

4. The ratchet tool of claim 1, wherein the thrust washer further comprises:
an overall-diameter measured at an outer peripheral edge;
an inner bore opening having an inner edge and an inner-height at said inner edge;
said outer peripheral edge having an edge-height adjacent said outer peripheral edge; and
wherein said inner-height and said outer-height are substantially equivalent.

5. A thrust washer for use in a ratchet tool, wherein the ratchet tool includes a shank spindle, a ratchet head including at least two members, a shank spindle output shaft, and at least one thrust washer, said thrust washer comprising:
a first surface and a second surface, each having an overall-diameter;
a peripheral surface having an edge-height;
an opening in said thrust washer, said opening having an edge, said edge having an edge-height, and said opening extending through the thrust washer from said first surface to said second surface, and said opening being concentric to said peripheral surface; and
wherein said first surface and said second surface are substantially parallel to each other.

6. The thrust washer of claim 5, wherein the thrust washer is characterized by having the same thickness at the edge of the opening and at the edge-height.

7. The thrust washer of claim 5, wherein the thrust washer is further characterized by an overall shape in the form of a ring having a continuous body.

8. The thrust washer of claim 5, wherein the thrust washer is further characterized by an overall shape in the form of a ring having a discontinuous body.

9. The thrust washer of claim 5, wherein the thrust washer is operationally mounted on the output shaft, and the output shaft is operationally mounted to the housing.

10. A method of reducing spreading of a ratchet head, said method comprising:
providing a ratchet head;
providing a shank spindle operationally connected to said ratchet head;
providing at least one thrust washer operationally connected to said shank spindle;
locating said thrust washer such that said thrust washer is operationally attached to the ratchet head and said shank spindle; and
providing the at least one thrust washer characterized by a diameter to height ratio such that spreading of the ratchet head is prevented.

11. The method of claim 10, wherein the step of locating said thrust washer further comprises locating said thrust washer such that said thrust washer is sandwiched between said ratchet head and said shank spindle.

12. A method of reducing spreading of a ratchet head comprising:
providing a shank spindle operationally connected to said ratchet head, wherein said ratchet head includes two members separated by a member gap having a member gap dimension;
providing at least one thrust washer operationally attached to said shank spindle, wherein said thrust washer has an edge-height dimension;
providing a shank spindle operationally attached to said ratchet head, wherein said shank spindle has a height dimension;
orienting said thrust washer such that said thrust washer is sandwiched in the member gap, between the ratchet head and the shank spindle; and
characterizing said thrust washer edge-height dimension and said shank spindle height dimension such that the combined structure of the thrust washer and the shank spindle substantially fills the member gap dimension to prevent spreading of the ratchet head.

13. A tool comprising:
a shank spindle operationally connected to a ratchet head;
a shank spindle output shaft operationally connected to said shank spindle, wherein said shank spindle output shaft is subjected to a lateral force, and wherein said lateral force tends to cause a corresponding movement in the head;
at least one thrust washer operationally attached to said shank spindle; and
wherein said at least one thrust washer prevents the corresponding movement in the head when said lateral force is applied.
